(19) United States
(12) Patent Application Publication
(10) Pub. No.: US 2008/0297753 A1
(43) Pub. Date: Dec. 4, 2008

(54) APPARATUS AND METHOD FOR DEFECT-FREE MICROLITHOGRAPHY

(75) Inventors: Fei Wang, Boise, ID (US); Ezequiel Vidal-Russell, Boise, ID (US); William A. Stanton, Boise, ID (US)

Correspondence Address: SCHWEGMAN, LUNDBERG & WOESSNER, P.A., P.O. BOX 2938, MINNEAPOLIS, MN, 55402, US

(73) Assignee: Micron Technology, Inc.

(21) Appl. No.: 11/756,307

(22) Filed: May 31, 2007

(51) Int. Cl. G03B 27/54

(52) U.S. Cl. 355/67; 355/77

(57) ABSTRACT

An illumination source pupil for microlithography includes a substrate of substantially opaque material having an x-axis and a y-axis defined with respect to the substrate. The substrate has a first arcuate opening therein, and a second arcuate opening therein. The substrate also includes a third opening therein positioned at the intersection of the x-axis and the y-axis.

### TECHNICAL FIELD

Various embodiments described herein relate to apparatus, systems, and methods associated with information storage and processing, including the operation and manufacture of a method and apparatus for removing scumming defects from microlithographic patterning.

### BACKGROUND INFORMATION

Step and repeat lithographic devices, called scanners or wafer steppers are commonly used to mass produce semiconductor devices, such as integrated circuits (ICs). Typically, a light source and various lenses are used to project an image of a mask onto a photosensitive coating of a semiconductor wafer. The projected image of the mask imparts a corresponding pattern on the photosensitive coating. This pattern may be used to selectively etch or deposit material to form the desired semiconductor devices. Of course, it is desirable to have very sharp features formed. For example, when forming a trench, there should be no unintended material left in the trench. However, at times, some portions of a feature may not be formed correctly. When forming a trench, sometimes all of the material which was intended to be removed is not completely removed to cause defects. The unremoved material or defect is sometimes referred to as scumming.

Having a trench with unremoved material can hinder performance of the device being formed. For example, if the formed trench is to be filled with conductive material, the unremoved material cuts down the size of the conductor. When considering the small size of such features the unremoved material, in some instances, can reduce the performance of the conductor and the device formed. In an extreme case, the device formed may fail. This problem may be more pronounced in the future as the dimensions associated with these devices become smaller. The problem may also appear at different dimensions of trenches when using different light sources having smaller or larger wavelengths in different microlithographic systems. Therefore, there is need to find an apparatus and method that removes scumming defects in formed features, such as trenches.

### BRIEF DESCRIPTION OF THE DRAWINGS

FIG. 1 is a schematic diagram of a microlithographic system, according to an example embodiment.

FIG. 2 is a top view of a mask showing a number of open areas in a substantially opaque layer, according to an example embodiment.

FIG. 3 is a top view of a quasar pupil for use in a microlithographic system.

FIG. 4 is a top view of a dipole pupil for use in a microlithographic system.

FIG. 5 is a top view of a target illuminated by a dipole source and showing features formed thereby, when using the dipole pupil of FIG. 4.

FIG. 6A is a diagram of illumination inner radius of the dipole source versus the trench width, when using the dipole pupil of FIG. 4.

FIG. 6B is a diagram of illumination inner radius of the dipole source versus the trench width, when using the dipole pupil of FIG. 4.

FIG. 6C is a diagram of illumination inner radius of the dipole source versus the spacing between trenches having a width of 0.24000 micrometers, when using the dipole pupil of FIG. 4.

FIG. 7A is a top view of a dipole pupil for use in a microlithographic system, according to an example embodiment.

FIG. 7B is a top view of a dipole pupil for use in a microlithographic system, according to an example embodiment.

FIG. 7C is a top view of a dipole pupil for use in a microlithographic system, according to an example embodiment.

FIG. 7D is a top view of a dipole pupil for use in a microlithographic system, according to an example embodiment.

FIG. 7E is a top view of a dipole pupil for use in a microlithographic system, according to an example embodiment.

FIG. 7F is a top view of a dipole pupil for use in a microlithographic system, according to an example embodiment.

FIG. 8A is a diagram of illumination inner radius of an illumination source using the source pupil of FIG. 7A versus the trench width, according to an example embodiment.

FIG. 8B is a diagram of illumination inner radius of an illumination source using the source pupil of FIG. 7A versus the spacing between trenches having a width of 0.24000 micrometers, according to an example embodiment.

FIG. 9 is a diagram comparing the Log-Slope for a Critical Dimension on a target for the dipole source pupil of FIG. 4 to the Log-Slope for a Critical Dimension on a target for the dipole source pupil of FIG. 7A, according to an example embodiment.

FIG. 10A is a diagram of the intensity threshold versus an amount of defocus in micrometers for the dipole source pupil of FIG. 4.

FIG. 10B is a diagram of the intensity threshold versus an amount of defocus in micrometers for the source pupil that includes an additional coherent feature, such as the source pupil 700 of FIG. 7A.

FIG. 11 is a flow diagram of a method, according to an example embodiment.

### DETAILED DESCRIPTION

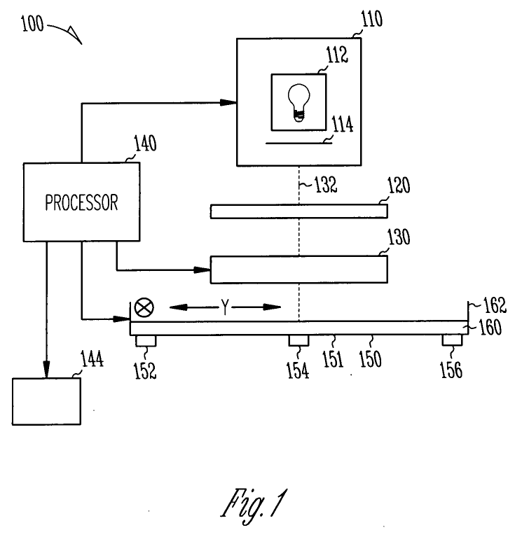

FIG. 1 is a schematic diagram of a microlithographic system 100, according to an example embodiment. The microlithographic system 100 is used in the manufacture of electronic devices and other mechanical devices using microlithography. The microlithographic system includes an illuminator 110, a mask or reticule 120, and a projection lens 130. The illuminator 110 includes an illumination or light source 112 and an source pupil 114. The microlithographic system is typically under the control of a microprocessor or processor 140 which is operatively coupled to an input device 144. The input device 144 is a keyboard, control panel, or other such apparatus as would allow an operator to input data or commands or to alter a computer program having an instruction set for controlling the projection device. In some embodiments of a microlithographic system 100, the illuminator or the target is moved and another image is exposed on the target. The microprocessor or processor 140 is used to automatically control the movement of the target or the illuminator 110 so that multiple exposures can be made on the target. In some embodiments, the target is a wafer having a layer of photoresist or photoresistive material thereon.

The illumination source 112 provides electromagnetic radiation of a predetermined variety in response to control signals from processor 140 coupled thereto. Typically, the radiation from illumination source 112 is in the visible light or ultraviolet wavelength range. The source pupil 114 is to modulate the intensity, phase, and illumination direction of the light radiation from the illumination source 112. The microlithographic system 100 also includes mask holder for holding the mask 120 in alignment with illumination source 112. The mask 120 includes a pattern of opaque and transparent regions in the path of radiation from illumination source 112 to cast a desired image into an optical subsystem. The optical subsystem includes the projection lens or pupil 130 and is configured to project an image along optical axis 132. The optical subsystem generally includes a series of lenses (not shown) to properly focus a received image and includes a controlled shutter coupled to processor 140 to selectively emit the image. Typically, an optical subsystem reduces the image size by a known factor relative to the size of the mask and, more specifically, to the size of the pattern on the mask 130. Of course, many microlithographic systems, such as the microlithographic system 100 include more components than the ones discussed here.

The microlithographic system also includes multistage positioning device 150. Multistage positioning device 150 is operatively coupled to processor 140 to be controlled thereby. Multistage positioning device 150 includes a base 151 and a wafer chuck 160 configured to securely hold a semiconductor wafer for lithographic processing by the microlithographic system 100. The positioning device 150 also has a number of independently controlled positioning stages to selectively position wafer chuck 160 relative to optical axis 132 of image microlithographic system 100.

The multistage positioning device 150 includes a stage 152, a stage 154 and a Z stage 156. The stage 152 positions wafer chuck 160 along a first axis (“X-axis”) perpendicular to the view plane of FIG. 1. Stage 152 responds to a first axis control signal from processor 140 to provide a corresponding X-axis position of wafer chuck 160. The stage 154 positions wafer chuck 160 along a second axis (“Y-axis”) generally perpendicular to the first axis. The stage 154 responds to a second axis control signal from processor 140 to provide a corresponding Y-axis position of wafer chuck 160. The second axis is generally parallel to the view plane of FIG. 1. The Z stage 156 is configured to move the chuck 160 along the Z axis. In some embodiments, the multistage positioning device includes a tilt stage to controllably pivot wafer chuck 160 about both the X-axis and Y-axis in response to an appropriate tilt control signal from processor 140. Various stages are moved by stepper motors under control of processor 140. As a result, such a microlithographic system is called a stepper microlithographic system or a scanner. A stepper or scanner is configured to mass produce integrated circuits by defining a matrix of spaced-apart exposure fields.

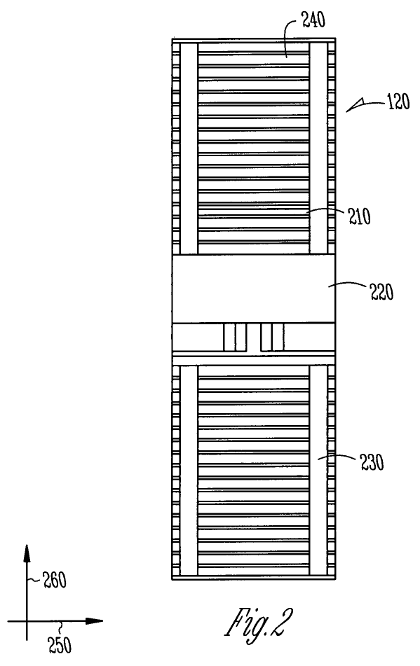

FIG. 2 is a top view of a mask 120 showing a number of open areas 210, 220, and 230 in a substantially opaque layer 240, according to an example embodiment. As shown in FIG. 2, the opaque layer 240 may include many small openings that are used to form features on a target, such as wafer. The mask 120 includes much larger open areas such as a center logic open area 220 or the space between dies, which is also referred to as the die-between-die open area 230. The center logic open area 220 of the mask 120 can have a number of features that are used to form the logic for the device. The center logic open area 220 may also includes a number of lines or trenches which serve to form lines or trenches on a target. These lines or trenches generally form electrical connectors to connect the various logical components formed on a wafer or target. The lines or trenches typically are formed parallel to an X-axis 250 or a Y-axis 260. These lines or trenches are formed parallel to one of the X-axis 250 or the Y-axis 260 since there are generally numerous connectors in a device and by organizing the connectors in this fashion, routing problems are reduced.

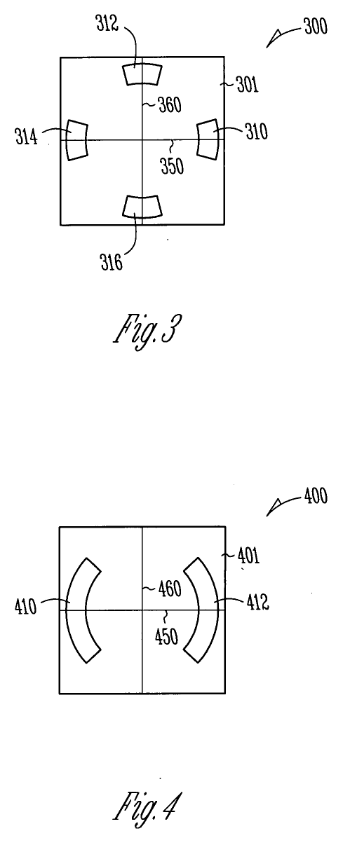

FIG. 3 is a top view of an source pupil 300 for use in a microlithographic system, such as the microlithographic system 100 (shown in FIG. 1). The source pupil 300 includes a first opening 310, a second opening 312, a third opening 314 and a fourth opening 316. The source pupil 300 includes a substrate 301 of substantially opaque material having an X-axis 350 and a Y-axis 360 defined with respect to the substrate 301. In one embodiment, the first opening 310 and the third opening 314 each traverse the X-axis 350. The second opening 312 and the fourth opening 316 each traverse the Y-axis 360. The source pupil 300 with the four openings 310, 312, 314, 316 distributes light over the mask 120 (shown in FIG. 1) but does not produce image of sharp contrast along features or patterns in the mask 120 (shown in FIG. 1) that are parallel with the X-axis 350 or the Y-axis 360 of the pupil or the X-axis 250 or the Y-axis 260 of the mask 120.

FIG. 4 is a top view of a dipole source pupil 400 for use in a microlithographic system, such as the microlithographic system 100 (shown in FIG. 1). The source pupil 400 includes a first opening 410, and a second opening 412. The source pupil 400 includes a substrate 401 of substantially opaque material having an X-axis 450 and a Y-axis 460 defined with respect to the substrate 301. In one embodiment, the first opening 410 and the second opening 412 each traverse the X-axis 450. The source pupil 400 with the two openings 410, 412 selectively distributes light over the mask 120 (shown in FIG. 1) and generally produces image of sharp contrast along patterns in the mask 120 (shown in FIG. 1) that are parallel with the Y-axis 260 of the mask 120. It should be noted that there are many different fashions of dipole pupils. The openings associated with the dipole source pupil 400 are arcuate in shape. The openings 410, 412 are defined by a spread angle φ, and the inner diameter and the outer diameter of the arcuate openings 410, 412. One way of defining a dipole is by noting the spread angle whether it subtends the X-axis 450 or the Y-axis 460, also including the diameter defining the dipole source pupil 400. As shown in this example, the spread angle φ is 60 degrees and the inner diameter of the arcuate openings is 0.76 (unitless, normalized to numerical aperture of the projection lens), and the outer diameter of the arcuate openings is 0.96 (unitless, normalized to numerical aperture of the projection lens). It should be noted that other dipole source pupils may have different spread angles φ. For example, the spread angle φ can be 35, 60, or 90 degrees. Generally, the spread angle φ is greater than zero degrees and less than 180 degrees. The inner and outer diameters can also be varied.

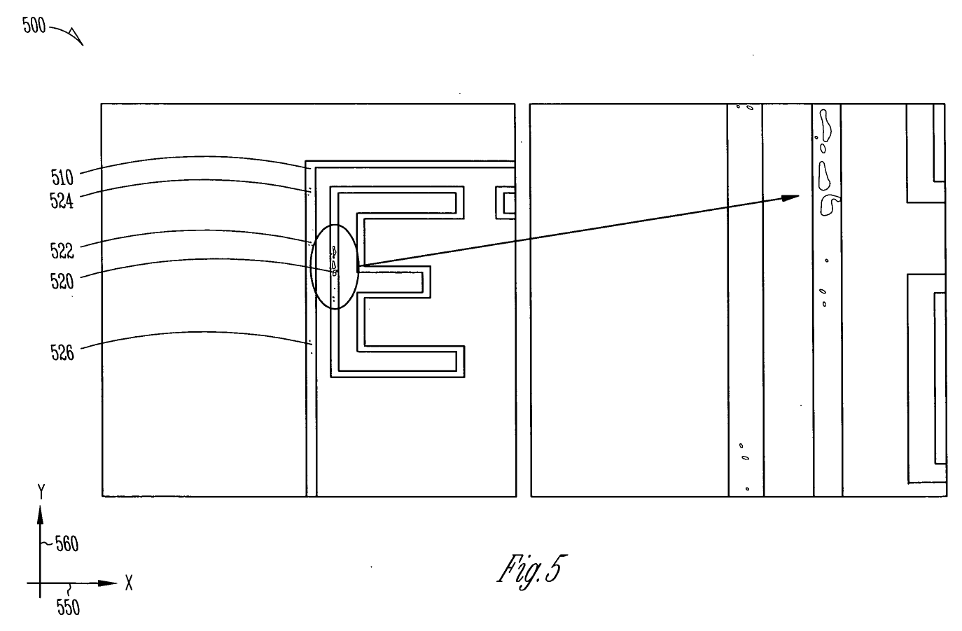

In some instances the light intensity associated with a dipole source pupil, such as dipole source pupil 400, may not produce the clearest or sharpest of features on a target. FIG. 5 is a top view of a target 500 having features formed using the dipole pupil of FIG. 4 as part of an illuminator in a microlithographic system, such as microlithographic system 100 (shown in FIG. 1). The dipole source pupil 400 (shown in FIG. 4) generally exposes features more completely in one direction than in another direction. It has been observed that in some instances the light intensity does not meet a threshold level in certain directions for features parallel to one of the X-axis of the mask or dipole, and the Y-axis of the mask or dipole. As shown in FIG. 5, the target 500 includes features 510 that are iso-trenches formed along or parallel to an X-axis 550, and along or parallel to a Y-axis 560. The features 510 include defects 520, 522, 524, 526. The defects are slight defects in the bottom of a trench or on top of an iso-trench in the feature 510. Some refer to the slight defects as scum or scumming. As shown in FIG. 5, the defects 520, 522, 524, 526 occur in a preferred direction, mainly along or parallel to the Y-axis 560. The preferred direction is the direction that is perpendicular to the axis traversed by the arcuate openings in the dipole source pupil 400 (shown in FIG. 4). In other words, the arcuate openings of the dipole source pupil 400 traverse the X-axis 460 the dipole source pupil 400 (shown in FIG. 4). It should be noted that the Y-axis 560 of the target 500 which includes the feature 510 corresponds or is parallel to the Y-axis 460 of the dipole pupil 400 (shown in FIG. 4) and the Y-axis 260 mask 120 (shown in FIG. 2).

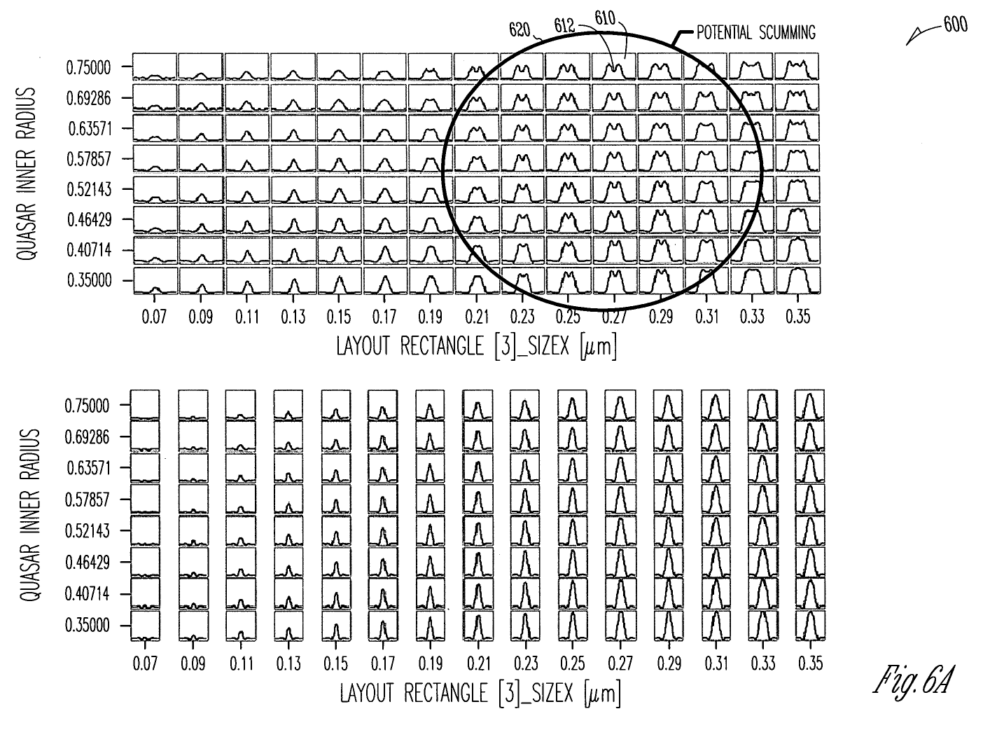

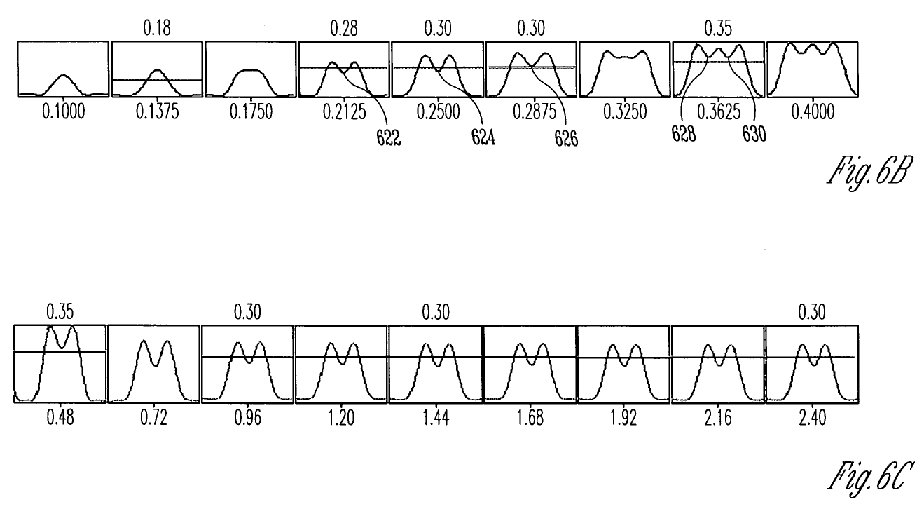

FIG. 6A is a diagram of illumination inner radius of the dipole source versus the trench width for a preferred direction, and a diagram of illumination inner radius of the dipole source versus the trench width for a non-preferred direction when using the dipole pupil of FIG. 4. FIG. 6A includes a number of individual graphs of light intensity as it varies across a trench. Each of the individual graphs are for dipoles having a selected inner diameters (on the y-axis of each of the diagrams) and a selected trench width (on the x-axis of each of the diagrams). FIG. 6A indicates the light intensity dips on trenches varying in width from 0.21 micrometers to 0.33 micrometers. For example, for a dipole having an inner radius equal to 0.75000 that is used in forming an iso-trench of 0.27 micrometers, as depicted by the reference number 610, the light intensity varies across the iso-trench and includes a dip 612 in the middle of the chart 610. The dip 612 in light intensity gives rise to a potential underexposure within the trench which can result in defects or scumming. As depicted by the circle 620, a number of combinations of dipoles with different inner diameters produce a similar dip when used to form iso-trenches of various widths. Therefore, for these combinations of dipoles with inner diameters of about 0.21 micrometers to about 0.35 micrometers versus iso-trench widths of from about 0.35 micrometers to about 0.75 micrometers, the potential for scumming exists. It should be noted that for different dipole source pupils having different spread angles, different outer sigmas, and different numerical aperture numbers, dipole scumming may be produced at different combinations of inner radii (different inner sigmas) and different trench widths.

FIG. 6B is a diagram of illumination inner radius of the dipole source versus the trench width, when using the dipole source pupil of FIG. 4. The diagram of FIG. 6B shows a set of illumination intensity graphs for a dipole having an inner radius of 0.69 σ versus several various trench widths in a preferred direction when using the dipole pupil of FIG. 4. One set of individual graphs of light intensity from the set of graphs shown in FIG. 6A. The individual graphs are for trench widths of 0.10 micrometers to 0.40 micrometers. Some of the individual light intensity graphs include a dip, such as the dips shown in FIG. 6A. For example, for a trench size of 0.2125 micrometers, the light intensity graph includes a dip 622; for a trench size of 0.2500 micrometers, the light intensity graph includes a dip 624; for a trench size of 0.2875 micrometers, the light intensity graph includes a dip 626; and for a trench size of 0.3825 micrometers, the light intensity graph includes a dip 628 and a dip 630. Also included in the individual graphs are lines parallel to the X-axis which represent a threshold level. When the threshold line intersects the graph of intensity at more than two points, there is a strong possibility of a defect being printed or formed. In other words, the dips correlate to a dip in the light intensity across a trench. When the dip is below the threshold level, the photoresist in the trench will not be fully exposed and may produce a scumming type defect. Therefore, graphs for trench widths of 0.2125 micrometers, 0.2500 micrometers, and 0.2875 micrometers show that features having these trench widths each have a possibility of having defects called scumming.

FIG. 6C is a diagram of illumination inner radius of the dipole source versus the spacing between trenches having a width of 0.24000 micrometers, when using the dipole pupil of FIG. 4. FIG. 6C shows that regardless of the spacing between trenches, the possibility of defects remains. Spacing between the features, such as trenches, is also termed the pitch, the possibility of defects remains. As shown in FIG. 6C, the possibility of printing or forming a defect in trenches having a critical diameter (CD) of 0.2400 micrometers is more or less the same as the pitch changes from 0.7200 micrometers to 2.4000 micrometers.

In some specific instances, the problem of printing defects or scumming can be partially improved by employing outriggers or by shifting the numerical aperture. However, such changes will prevent scumming for specific trenches but may not work as soon as the numerical aperture, the pitch, or the trench width changes.

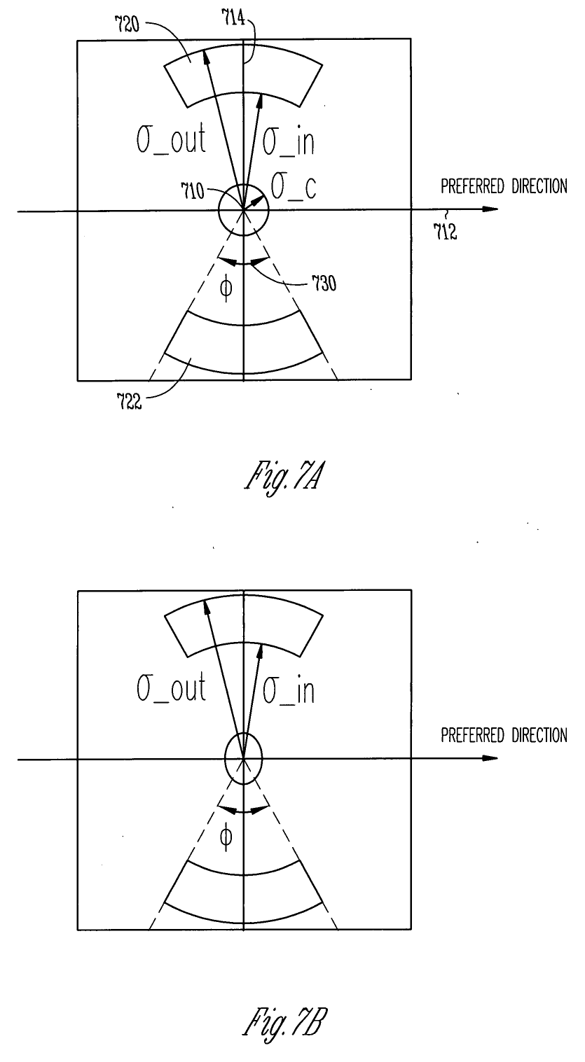

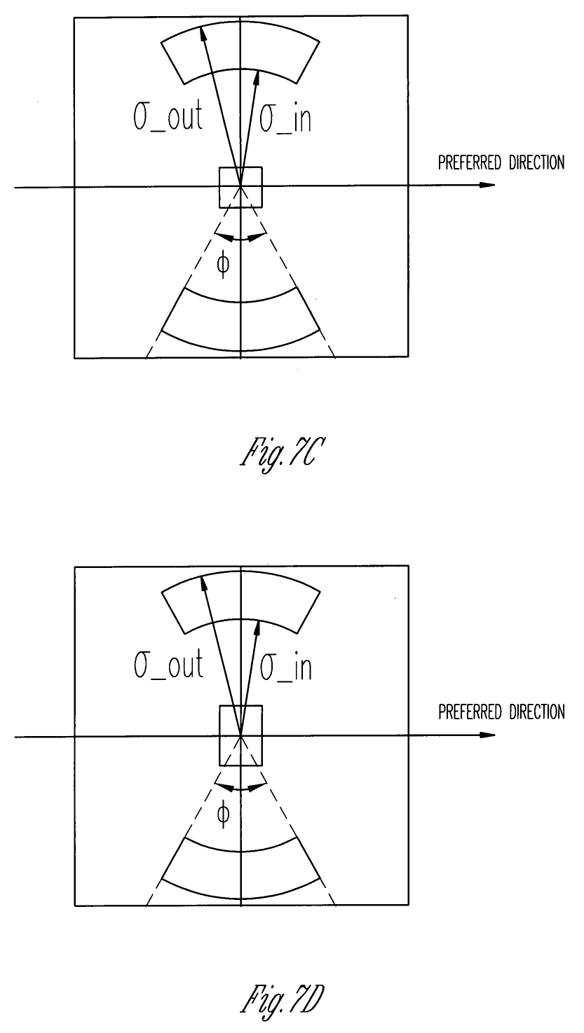

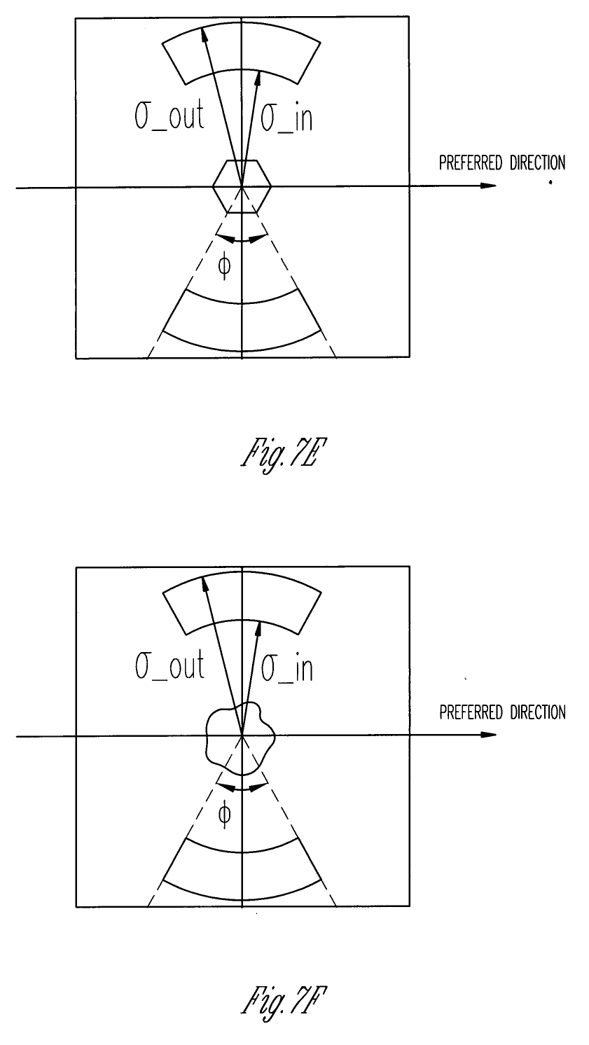

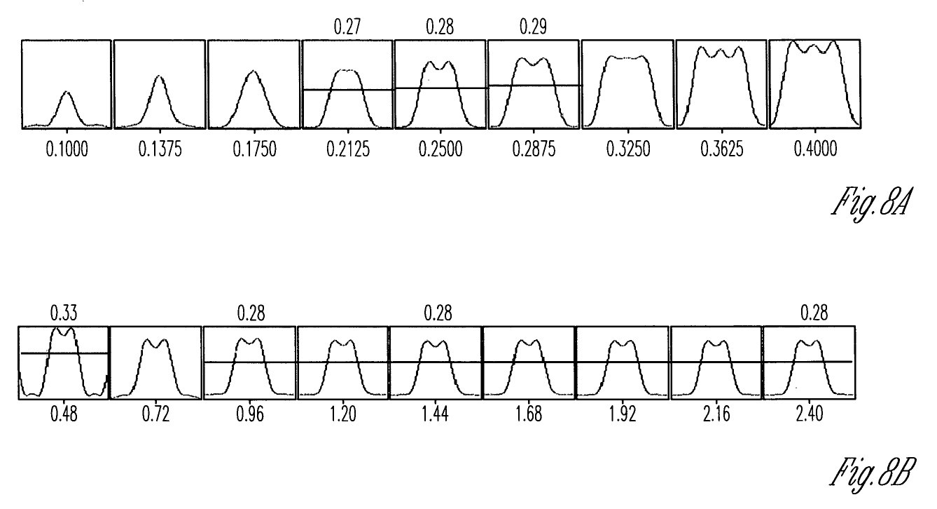

FIG. 7A is a top view of an source pupil 700 for use in a microlithographic system 100 (shown in FIG. 1), according to one embodiment of the invention. The source pupil 700 is a dipole that also includes a third opening or a coherent portion 730. The source pupil 700 includes a substrate 710 of substantially opaque material having an x-axis 712 and a y-axis 714 defined with respect to the substrate 710. The substrate 710 has a first arcuate opening 720 therein, and a second arcuate opening 722 therein. The first arcuate opening 720 and the second arcuate opening 722 transverse one of the x-axis or the y-axis. As shown in FIG. 7A, the first arcuate opening 720 and the second arcuate opening 722 transverse the y-axis 714. The substrate also includes a third opening 730 positioned between the first arcuate opening 720 and the second arcuate opening 722. In one embodiment, the third opening 730 is positioned at the intersection of the x-axis 712 and the y-axis 714. The third opening 730 can be any coherent feature. The source pupil 700 has the pole spread angle, φ, generally ranging from >0° to <180°. In some example embodiments, values of φ would be 35°, 60°, and 90°.

The source pupil 700 is entitled with the partial coherence defined by the triplet {σ_c, σ_in, σ_out} with the requirement 0<σ_c<σ_in<σ_out<1 for a dry stepper/scanner tool. Low values of σ_c (<0.4) and high values of σ_in and σ_out (>0.6) suppress the dipole-associated scumming anomolies while providing acceptable imaging qualities for features throughout size and pitch. The coherent feature is not limited to a circle. The coherent feature can be of any shape including circular, elliptical, or rectangular, square, polygonal, or an irregular shape. FIGS. 7B, 7C, 7D, 7E and 7F show various shapes for the third opening or additional coherent feature. In one embodiment of the source pupil 700, the substrate 710 has only two arcuate openings 720, 722 therein. In addition, the X-axis 712 and the Y-axis 714 of the pupil are substantially parallel to a set of features to be formed using the light source. The addition of a coherent feature, such as circle or opening 730 in FIG. 7A, shifts the light intensity upward across a trench or feature.

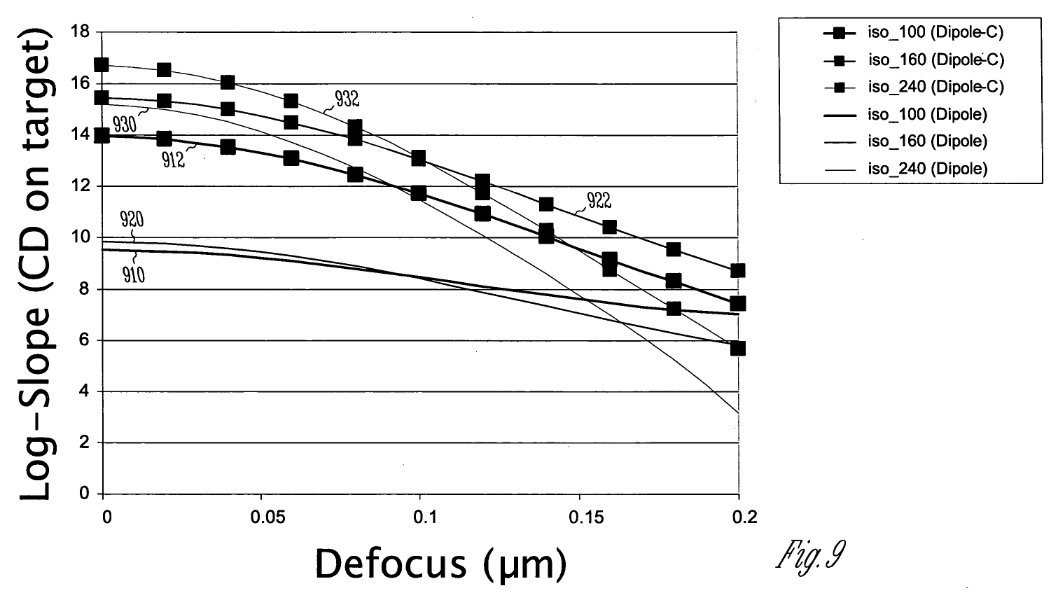

FIG. 8A is a diagram of illumination inner radius of an illumination source using the an source pupil 700 of FIG. 7A versus the trench width, according to an example embodiment. The diagram of FIG. 8A shows a set of illumination intensity graphs for a dipole having an outer radius of 0.96 sigma, an inner radius of 0.69 sigma, and a circular opening of 0.30 σ versus various trench widths from 0.10 micrometers to 0.40 micrometers. Individual light intensity graphs it can be seen that the source pupil 700 (shown in FIG. 7A) increases the light intensity to levels above the threshold levels (horizontal lines). In many instances the severity of any dip in the intensity of the light is substantially lessened, for instance in trench widths of 0.2125 micrometers, 0.2500 micrometers, and 0.2975 micrometers. The plot of the light intensity more closely resembles a square wave and any dip in the light intensity is above the light intensity threshold levels. As a result, the light intensity is sufficient so that a feature, such as an iso-trench, is not fabricated a defect such as scumming. Use of the source pupil 700 (shown in FIG. 7A) results in improved light intensity despite the size of the feature, as compared to individual light intensity graphs of FIG. 6B.

FIG. 8B is a diagram of illumination inner radius of an illumination source using the an source pupil 700 of FIG. 7A versus the spacing between trenches having a width of 0.24000 micrometers, according to an example embodiment. The use of the source pupil 700 (shown in FIG. 7A) increases the light intensity to levels above the threshold levels despite changes in the spacing (pitch) between trenches. The dips in light intensity are less severe at each pitch when compared to similar set of graphs shown in FIG. 6C for light intensities related to spacing for a dipole source pupil, such as shown in FIG. 4. When compared to FIG. 6C, the plot of the light intensity at each spacing or pitch value, more closely resembles a square wave and any dip in the light intensity is above the light intensity threshold levels (horizontal line). As a result, the light intensity is sufficient so that the feature, such as an iso-trench of 0.2400 micrometers, is not fabricated with a defect such as scumming. It can also be seen that use of the source pupil 700 (shown in FIG. 7A) results in improved light intensity despite the spacing between features.

FIG. 9 is a diagram comparing the Log-Slope for a Critical Dimension (CD) on a target for the dipole source pupil 400 of FIG. 4 to the Log-Slope for a CD on a target for the dipole source pupil 700 of FIG. 7A, according to an example embodiment. The value of log slope for a particular CD is a measure of the ability of an illuminator to produce sharp features in a target. The log slope is for isolated lines having a CD of 0.10 micrometers, 0.16 micrometers and 0.24 micrometers. In each case, the log slope values for a feature having the corresponding CD is higher for the source pupil 700 (shown in FIG. 7A) when compared to the source pupil 400 (shown in FIG. 4). The log slope is also improved when compared to various amounts of defocus, indicated in micrometers, as well. For example, at the smallest feature size of 0.10 micrometers, the plot of log slope versus the amount of defocus for the source pupil 400 is depicted by the curve 910. When using the same illuminator with source pupil 700 the log slope versus the amount of defocus curve is depicted by reference numeral 912 and shows improvement. With a slightly larger target critical dimension of 0.16 micrometers the plot of log slope versus defocus for the dipole source pupil 400 is represented by the curve 920. The corresponding curve when using the source pupil 700 is depicted by reference numeral 922. Again, there is an improvement of the log slope at various defocus values. Even with a much larger feature size of 0.24 microns there is improvement as shown by the curve 930 that shows the log slope plot versus defocus for the source pupil 400 and the curve 932 which shows the plot of log slope versus the amount of defocus for the source pupil 700.

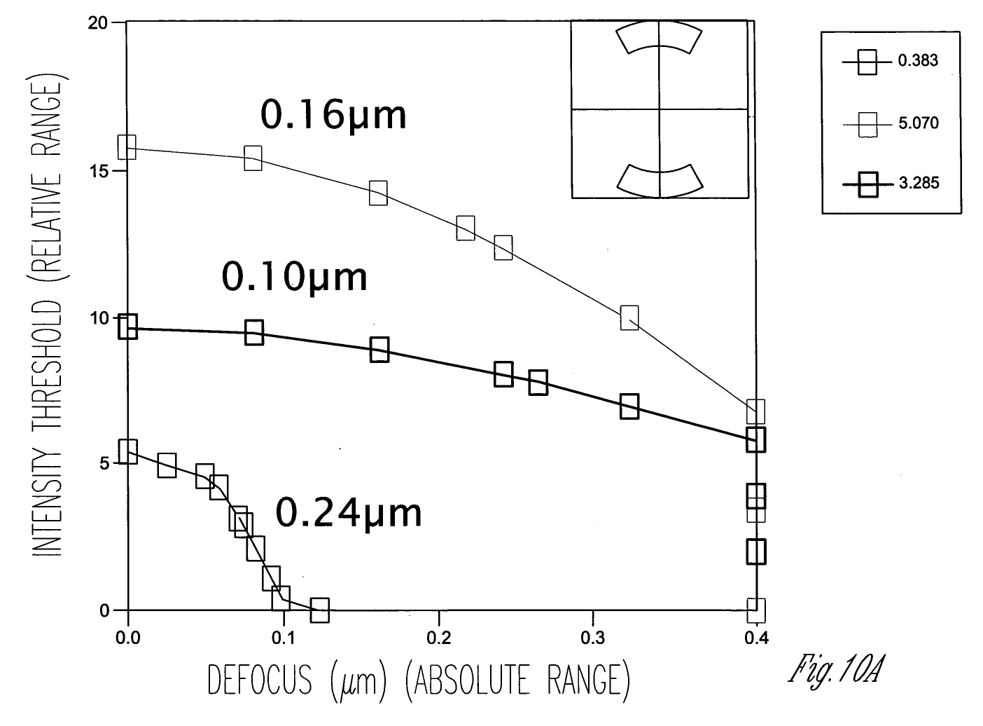

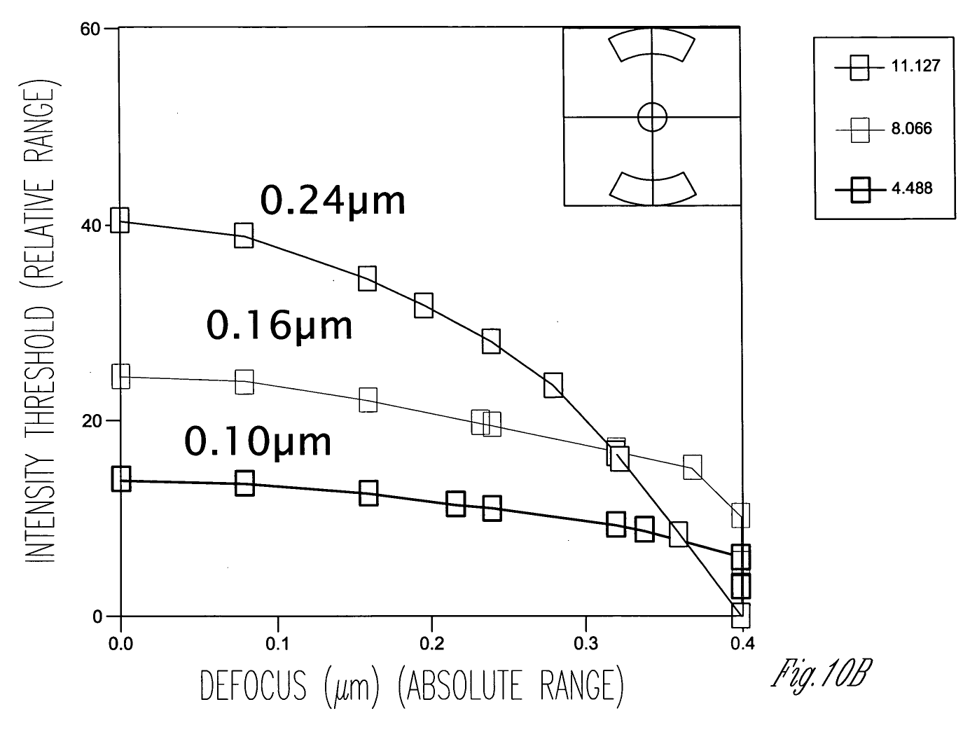

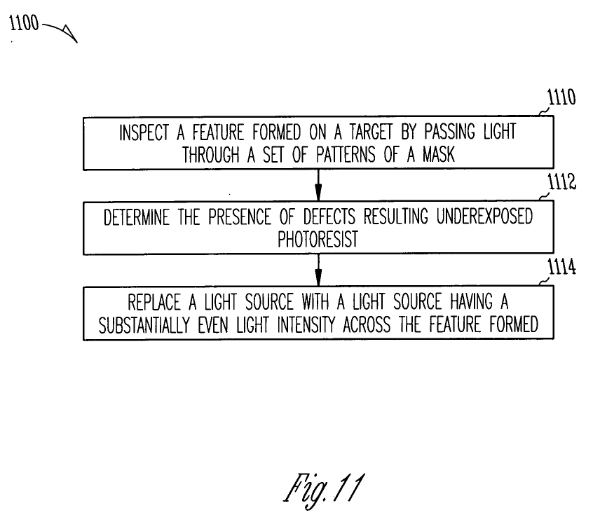

FIG. 10A is a diagram of the intensity threshold (Y-axis) versus the amount of defocus in micrometers (X-axis) for dipole source pupil 400 of FIG. 4. The area below the curves indicate a process window of the amount of defocus that can be tolerated without producing defects for the various CDs used. Also the amount of area below the plot is indicative of the size of the process window or the ability to produce features without having defects. The area below the process window graph is identified in the box to the right of the graph shown in FIG. 10A. For example, for the process window for the critical dimension of 0.24 micrometers has a total area of 0.3833 units while the process window for the critical dimension of 0.101 micrometers has a total area of 3.285 units and the process window for the critical dimension of 0.16 micrometers has a total area of 5.070 units.

FIG. 10B is a diagram of the intensity threshold versus an amount of defocus in micrometers for the source pupil that includes the additional coherent feature such as the source pupil 700 of FIG. 7A. Again, the curve associated with a feature having a critical dimension of 0.24 micrometers is elevated when compared to the corresponding curve in FIG. 10A. In addition, the amount of area associated with the process window is 11.27 units. The curve of the intensity threshold versus the amount of defocus for the 0.16 micrometers is also shown in FIG. 10B. The corresponding area of 8.066 units is also improved, although not as much as the improvement for the 0.24 micrometer feature. In addition, the curve for the 0.101 micrometer feature shows improvement and the area of the process window is also elevated when compared to the similar graph shown in FIG. 10A. Therefore, the use of the source pupil 700, which includes the coherent feature (third opening 730), improves the process window for the various critical dimensions as shown by a comparison of the graphs of FIG. 10A to the graphs of FIG. 10B.

FIG. 11 is a flow diagram of a method 1100, according to an example embodiment. The method 1100 includes inspecting a feature formed on a target by passing light through a set of patterns of a mask 1110, determining the presence of defects 1112 resulting underexposed photoresist, and replacing a light source with a light source having a substantially even light intensity across the feature formed 1114. Replacing the light source 1114 includes placing an additional opening in a pupil associated with the light source. In another embodiment, replacing the light source 1114 includes placing an additional opening between a first arcuate opening in a pupil and a second arcuate opening in the pupil.

A microlithographic system 100 includes a mask 120, and an illuminator 110. The mask 120 includes at least one opaque area and at least one opening within the opaque area. The mask 120 also includes patterns for forming features parallel to an X-axis and parallel to a Y-axis. The illuminator 110 includes a light source 112, and a pupil, such as source pupil 700 shown in FIG. 7A or other source pupils shown in FIGS. 7B-7F. The pupil 700 includes a substrate 710 of substantially opaque material. The substrate 710 has a first arcuate opening 720 therein, a second arcuate opening 722 therein, and a third opening 730 therein. The first arcuate opening 720 and the second arcuate opening 722 traverse one of the X-axis 712 or the Y-axis 714. The third opening 730 is positioned between the first arcuate opening 720 and the second arcuate opening 722. In one embodiment, the third opening 730 may be positioned at the intersection of the X-axis 712 and the Y-axis 714. The microlithographic system 100 may also include a projection lens 130 for directing the light onto a target. The projection lens 130 directs light onto the target after it passes through the mask 120. In the microlithographic system 100 the pupil 700 may include a third opening 730 of any shape, such a polygon, an ellipse, an annulus, or an irregular shape. The pupil 700 is shaped to even out an amount of light intensity projected through the mask 120. In one embodiment, the pupil 700 is shaped to even out an amount of light intensity projected through the mask 120 on at least one of the x-axis or the y-axis.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. § 1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A pupil comprising:
a substrate of substantially opaque material;
an x-axis defined with respect to the substrate;
a y-axis defined with respect to the substrate, the substrate further comprising:
a first arcuate opening; and
a second arcuate opening, wherein the first arcuate opening and the second arcuate opening transverse one of the x-axis or the y-axis, the substrate also including a third opening therein positioned at the intersection of the x-axis and the y-axis.

2. The pupil of claim 1 wherein the third opening is circular.

3. The pupil of claim 1 wherein the third opening is elliptical.

4. The pupil of claim 1 wherein the third opening is rectangular.

5. The pupil of claim 1 wherein the third opening is square.

6. The pupil of claim 1 wherein the third opening is a polygon.

7. The pupil of claim 1 wherein the substrate has only two arcuate openings therein.

8. The pupil of claim 1 wherein the x-axis and the y-axis of the pupil are substantially parallel to a set of features to be formed using a light source.

9. A microlithographic system comprising:
a mask that includes at least one opaque area and at least one opening within the opaque area, the mask including patterns for forming features;
an illuminator comprising:
a light source; and
a pupil comprising:
a first arcuate opening;
a second arcuate opening, wherein the first arcuate opening and the second arcuate opening transverse one of the x-axis or the y-axis, and
a third opening positioned between the first arcuate opening and the second arcuate opening.

10. The microlithographic system of claim 9 wherein the third opening is positioned at the intersection of the x-axis and the y-axis.

11. The microlithographic system of claim 9 further comprising a projection lens for directing the light onto a target.

12. The microlithographic system of claim 9 wherein the pupil is shaped as a polygon.

13. The microlithographic system of claim 9 wherein the pupil is elliptical.

14. The microlithographic system of claim 9 wherein the pupil is annular.

15. The microlithographic system of claim 9 wherein the pupil is irregularly shaped.

16. The microlithographic system of claim 9 wherein the pupil is shaped to even out an amount of light intensity projected through the mask.

17. The microlithographic system of claim 9 wherein the pupil is shaped to even out an amount of light intensity projected through the mask on at least one of the x-axis or the y-axis.

18. A method comprising:
inspecting a feature formed on a target by passing light through a set of patterns of a mask;
determining the presence of defects resulting in underexposed photoresist; and
replacing a light source with a light source having a substantially even light intensity across the feature formed.

19. The method of claim 18 wherein replacing the light includes placing an additional opening in a pupil associated with the light source.

20. The method of claim 18 wherein replacing the light includes placing an additional opening between a first arcuate opening in a pupil and a second arcuate opening in the pupil.
